(19) United States
(12) Patent Application Publication
(10) Pub. No.: US 2015/0278854 A1
(43) Pub. Date: Oct. 1, 2015

(54) METHOD AND SYSTEM FOR TARGETING ONLINE ADVERTISEMENTS

(71) Applicant: MASTERCARD INTERNATIONAL INCORPORATED, Purchase, NY (US)

(72) Inventor: Justin Xavier Howe, San Francisco, CA (US)

(73) Assignee: MASTERCARD INTERNATIONAL INCORPORATED, Purchase, NY (US)

(21) Appl. No.: 14/226,108

(22) Filed: Mar. 26, 2014

(51) Int. Cl. G06Q 30/02

(52) U.S. Cl. CPC G06Q 30/0251

(57) ABSTRACT

An electronic message containing reservation data is received. The reservation data of the electronic message is parsed with a computer processor to identify a planned future travel activity of a customer. An identifier associated with the customer and at least one attribute of the planned future travel activity are stored at a computer database. A request is received for an advertisement to be displayed to the customer. One or more of the attributes are retrieved from the database. An advertisement targeted to the customer is selected based on the retrieved attribute(s).

### FIELD

Aspects of the present disclosure relate in general to targeting relevant advertisements to individuals, and more particularly to targeting advertisements in an online advertisement context based on information originating from consumers.

### BACKGROUND

The advertising industry has experienced significant growth and change as consumers have moved many of their activities to the Internet and computers. As users spend more time during the day on the computer, the number of advertisements (ads) presented over the computer has increased. These days, advertising is a major source of revenue for many companies and individuals that have websites. Users browsing the web encounter advertisements of various kinds, with some being helpful to the users and others (perhaps the majority) being unhelpful to users and/or undesired on the part of users.

A challenging aspect of digital advertising is that the Internet by its very nature makes possible a global exchange of ideas and enables a global marketplace. It is possible for users from around the world, of varying socioeconomic levels and educational levels, to visit the same website. Therefore, merchants who might consider placing an advertisement for their products on a given website often have uncertainties as to how effective such an advertisement will be in reaching the intended audience, e.g., likely consumers of the merchants' goods or services. Therefore, targeting advertisements effectively is an important goal in the modern online advertising landscape.

### SUMMARY

In some embodiments of the present disclosure, an electronic message containing reservation data is received. The reservation data of the electronic message is parsed with a computer processor to identify a planned future travel activity of a customer. An identifier associated with the customer and at least one attribute of the planned future travel activity are stored at a computer database. A request is received for an advertisement to be displayed to the customer. One or more of the attributes are retrieved from the database. An advertisement targeted to the customer is selected based on the retrieved attribute(s).

In some embodiments, a confirmation of an order placed by a customer is sent to the customer. The order pertains to at least a portion of a planned future travel activity of the customer. A state object including data representing at least one attribute associated with the order is generated. The state object is sent to a computer of the customer. The state object is stored on the computer of the customer. A data authority is enabled to learn one or more of the attributes associated with the order.

In some embodiments, first data is received, wherein the first data enables a data authority to interpret a state object stored at a computer of a customer. The state object includes second data representing at least one attribute associated with an order placed by the customer. The order pertains to at least a portion of a planned future travel activity of the customer; The state object is received, and from the received state object and using the first data, one or more of the attributes associated with the order are determined. An advertisement targeted to the customer is selected based on the determined one or more attributes.

### BRIEF DESCRIPTION OF THE DRAWINGS

The following will be apparent from elements of the figures, which are provided for illustrative purposes and are not necessarily to scale.

FIG. 1A is an illustration of processing associated with storing relevant information in an advertising database in accordance with some embodiments of the present disclosure.

FIG. 1B is an illustration of a targeted advertising technique based on previously stored information in accordance with some embodiments.

FIGS. 2A-2B are illustrations of targeted advertising based on a stored state object in accordance with some embodiments.

FIG. 3 is an illustration of relationships between various digital advertising participants for whom targeted advertising in accordance with some embodiments may be beneficial.

FIG. 4 is an architecture diagram of a computer 400 that may be used in some embodiments.

FIG. 5 is an illustration showing an example of using itinerary data for enriching other data for advertising purposes, in accordance with some embodiments.

FIG. 6 is an illustration of a technique for matching device data to purchasing data in accordance.

FIG. 7 is a flow diagram of a process in accordance with some embodiments.

FIG. 8 is a flow diagram of a another process in accordance with some embodiments.

FIG. 9 is a flow diagram of another process in accordance with some embodiments.

### DETAILED DESCRIPTION

This description of the exemplary embodiments is intended to be read in connection with the accompanying drawings, which are to be considered part of the entire written description.

Various embodiments of the present disclosure provide effective targeted advertising to users who visit a website. Various embodiments are based on the following insight regarding advertising. Generally, it is difficult to know what consumers are likely to do in the future. Indeed, this difficulty is a topic that is central to the field of advertising. It is of limited utility or no utility to present an advertisement for a product or service to a person who is disinclined to purchase, or incapable of purchasing, the product or service. It is difficult to know beforehand what consumers are likely to do or purchase in the future. But, in some circumstances it is possible to glean information about a person's future activities. Specifically, when a person has made it known that he or she will be in a certain place during a certain time or time frame, the prospects for targeting advertisements improve considerably. Placing constraints on a person's future temporal and spatial attributes enables certain candidate advertisements to be ruled out as inapplicable and others to be identified as relevant. Even when a person has made it known to somebody that the person will be in a certain place during a certain time frame, another challenge is tapping that information and making effective use of it. Various embodiments solve these challenges as described below and in the accompanying drawings.

For convenience, examples pertaining to flight reservations are described in this disclosure, but embodiments of the present disclosure are not so limited and may apply to reservations or orders of various types of products and services. For example, various embodiments may apply to any scenario in which a merchant provides a service associated with a known location and time or time frame, e.g., hotel reservations, car rental reservations, rail travel, cruises, event ticket purchases, restaurant reservations, and the like. Similarly, although airline merchants are described in various examples, any merchant may be applicable for various embodiments.

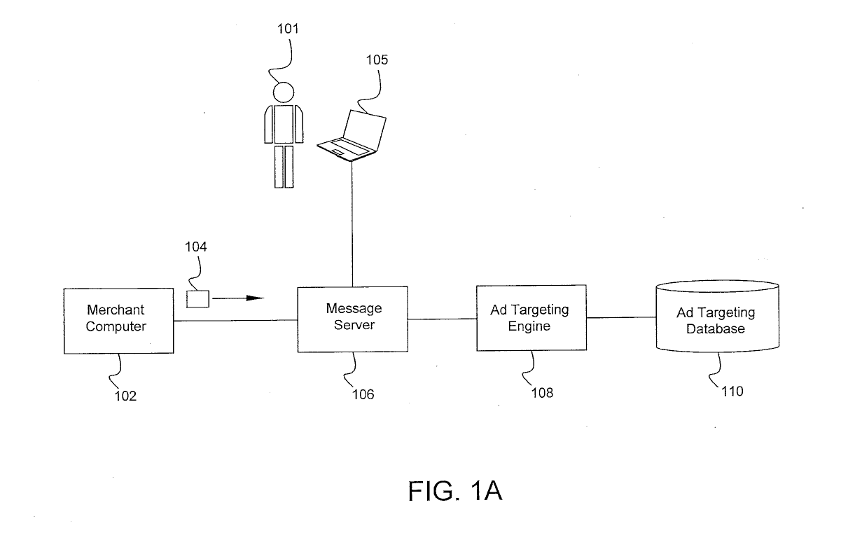

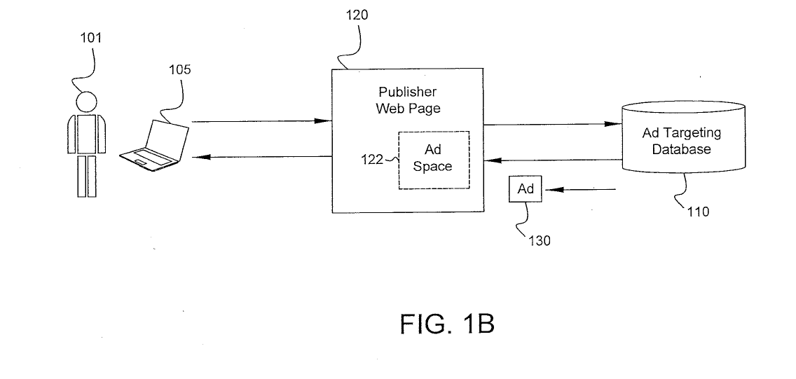

FIG. 1A is an illustration of processing associated with storing relevant information in an advertising database. Referring to FIG. 1A, a consumer 101 (sometimes referred to as a user) uses an electronic device 105 for accessing electronic messages. Electronic device may be a computer, a smartphone, or any other type of electronic device capable of displaying messages and communicating with a message server 106. Message server 106 is a server capable of serving messages, e.g., email messages, text messages (e.g., SMS text messages), voice mail messages, or any other type of electronic messages.

In some embodiments, in response to consumer 101 making a reservation for airline flights with a merchant (e.g., an airline merchant), an electronic message 104 is sent consumer 101 via message server 106. The connections between merchant computer 104 and message server 106, and between user device 105 and message server 106, may be via a network such as the Internet (not shown in FIG. 1A).

In one example, message 104 may be a confirmation email that includes relevant information about the flight that has been booked, e.g., the flight number, dates of travel, cities or airports of departure and arrival, etc. As one example, message 104 may include information specifying that consumer 101 will be traveling on a flight departing from New York JFK Airport (airport code JFK) on Jul. 1, 2014 at 8:00 a.m. local time and arriving at London Heathrow Airport (airport code LHR) that day at 8:00 p.m. local time, and that consumer 101 has a return flight scheduled to depart from London Heathrow Airport on Jul. 14, 2014 at 8:00 a.m. local time and arrive at JFK Airport at 11:00 a.m. local time that day. Information regarding the travel itinerary may be formatted in various ways, as one of ordinary skill in the art understands. For example, the Ticket Control Number (TCN) format is one such format for itinerary data.

Based on the transmitted message 104 containing information regarding the reservation made by consumer 101, information pertinent to advertising can be obtained and processed for targeted advertising. An advertising targeting engine 108 includes software and/or hardware for receiving electronic message 104, scanning message 104, determining that it is a travel confirmation message (e.g., confirmation email), and automatically parsing data from message 104, e.g., data regarding at least one planned future travel activity for consumer 101. Referring to the foregoing example, the destination of the travel may thus be determined to be London (and more particularly, Heathrow Airport), and the duration of travel may be determined as well.

A unique advertising identifier (ad ID) may be associated with each person. For example, the ad ID may be the user ID that a person enters at an appropriate prompt for receiving his or her email (or other form of messages). Or, in the case of a text message, the ad ID may be the same as or based on any of a variety of identifiers commonly used in cellular telephony (e.g., a mobile handset identifier, or a phone number, or any other identifier). In some embodiments, a single ad ID is used by a company to identify a user who accesses any of the company's product offerings regardless of platform, operating system, or hardware device. Regardless of the specific form of the ad ID, the advertising targeting engine 108 stores the ad ID and the itinerary information (e.g., at least one attribute of the planned future travel activity, such as a time attribute or a place attribute) at an advertising targeting database 110.

FIG. 1B is an illustration of targeted advertising based on previously stored information. Once the ad ID and itinerary information have been stored at advertising targeting database 110, advertisements can be targeted to users as follows. Suppose user 101 uses an electronic device (here labeled as 105, but possibly different than the device shown as 105 in FIGS. 1A-1B) to visit a web page 120 (e.g., using a web browser that retrieves a web page with the HTTP or HTTPS protocols). It should be understood that entities that have websites and display advertisements to users of their websites and thus earn income from that display are referred to as publishers. Therefore, web page 120 may be referred to as a publisher web page. When user 101 requests to visit publisher web page 120, e.g., by entering in a browser the corresponding universal resource locator (URL) or selecting in a browser a bookmark corresponding to the web page), the ad ID for user 101 is discerned. For example, if user 101 uses a web browser to visit web page 120 while being logged into his or her email (e.g., with another tab or window of the web browser), the user is recognizable by his or her ad ID. Publisher web page 120 is not immediately served to the web browser of user 101. Instead, advertising targeting database 110 is contacted (e.g., by the web server corresponding to web page 120, or by another computer connected to that web server). This communication, which includes transmission of the ad ID for user 101, is essentially a request to advertising targeting database 110 for a relevant advertisement that will fill a vacant ad space 122 in publisher web page 120.

Advertising targeting database 110 uses the provided ad ID to look up the previously stored itinerary information for user 101. This lookup may include retrieving one more of the attributes regarding user 101's planned future travel activity. These retrieved attributes may include a time attribute (e.g., a specific time, a time interval, or a set of times, where time can be measured/recorded in various ways, such as date, or hours/minutes/seconds on a particular date, etc.), a place attribute (e.g., one or more locations or regions), or both. Based on that itinerary information (e.g., based on the retrieved one or more attributes regarding user 101's planned future travel activity), an advertisement 130 targeted to user 101 is selected (e.g., using a processor connected to database 110, not shown). This selection may be enabled by a time tag or a place tag that is associated with each advertisement at advertisement targeting database 110. For example, continuing the example mentioned above, an advertisement for a music festival in London on Jul. 3, 2014 may be selected because it is likely that user 101 will be in London on that date. Another possibility is selecting advertisement for a ground transportation service (e.g., car rental service, bus service, taxi service, train service, etc.) at Heathrow airport, because it is likely that user 101 might need such services.

If other stored information regarding the travel itinerary of user 101 indicates that he or she will be leaving for Madrid on Jul. 2, 2014, then advertising targeting database 110 may select an advertisement 130 involving a service in Madrid on Jul. 3, 2014 rather than the Jul. 3 festival in London. In other words, multiple sets of itinerary data may be provided to advertising target database 110, and the likely time and place information for user 101 can be determined on that basis. The selected advertisement 130 is provided to publisher web page 120 (e.g., by transmitting the advertisement 130 to a web server corresponding to the web page 120) and is controlled to occupy ad space 122 within the web page 120. The publisher web page 120 containing the selected advertisement 130 is then served to user device 105 so that user 101 can view the selected advertisement 130.

Thus, user 101 who is browsing websites on the Internet can be presented with advertisements that are likely to appeal to him/her by virtue of being related to the trip which user 101 will be taking. User 101 may consequently be more inclined to click these targeted advertisements, and thus generate revenue for the publisher corresponding to publisher web page 120, than he/she otherwise might be.

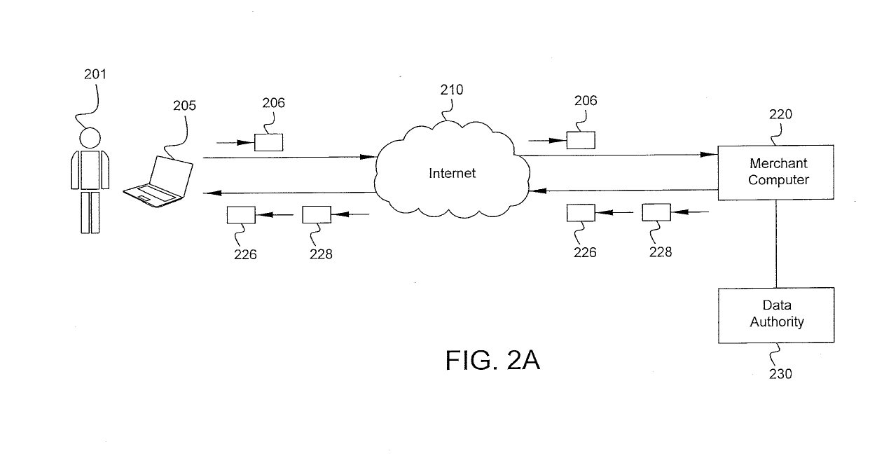

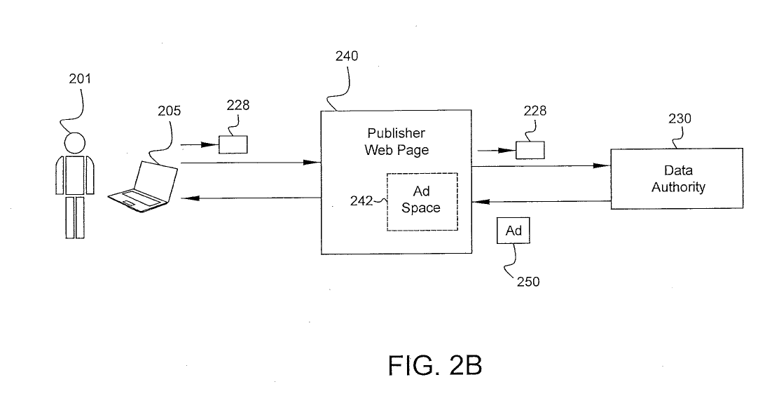

FIGS. 2A-2B are illustrations of targeted advertising based on a stored state object in accordance with another embodiment of the present disclosure. In the example of FIGS. 2A-2B, a stored state object is used to convey information regarding a travel itinerary. More generally, embodiments are applicable to an order placed by a user pertaining to at least a portion of any planned future activity of the user. Suppose user 201 uses electronic device 205 to reserve airline flights with the same details as in the example above (New York JFK to London Heathrow, Jul. 1, 2014 through Jul. 14, 2014, etc.). When the flights are booked, a payment authorization message 206 is sent (e.g., via a network such as the Internet 210) from user device to merchant computer 220 associated with the airline merchant that offered the flights. In response, merchant computer 220 sends an order confirmation message 226 to user device 205 and also generates a state object 228 containing details of the trip itinerary (e.g., details similar to those contained in the confirmation message 104 in the example of FIG. 1A). The state object 228 is sent to user device 205 and stored on user device 205. The state object may be a browser cookie (e.g., an HTTP cookie), and it may be a file that is stored on user device 205 to enable state information to persist across multiple visits to a web page or multiple web sessions or transactions. State objects/cookies are well-known and are described at, e.g., U.S. Pat. No. 5,774,670 to Montulli entitled “Persistent Client State in a Hypertext Transfer Protocol Based Client-Server System,” the entire contents of which are hereby incorporated by reference herein.

The state object 228 may be encrypted to prevent unauthorized access. If the state object 228 is encrypted, the contents of the state object 228 can later be accessed based on information sent from merchant computer 220 to a data authority 230 that enables such information to be accessed and interpreted correctly. Generally, data authority 230 may be any entity separate from merchant computer 220 that is trusted with participating in targeted advertising, or a computer associated with such an entity. Specific examples of data authorities may include data exchanges and/or data management platforms (DMP's) with whom the airline merchant has a revenue sharing agreement, which incentivizes the merchant to provide information to data authority 230. It should be understood that a data exchange is an online auction marketplace where advertisers acquire third party data that helps them better reach their target audiences regarding advertisements. It should further be understood that a DMP is a centralized data management platform that enables creation of target audiences based on a combination of in-depth first-party and third-party audience data; accurately target campaigns to these audiences across third-party ad networks and exchanges, and accurately measure which campaigns performed the best across segments and channels to refine media buys.

One approach for enabling data authority 230 to later be able to access the contents of state object 228 is for merchant computer 220 to provide data authority 230 with a decryption key that allows data authority 230 to decrypt any state objects placed by merchant computer 220 without any effort by the airline merchant beyond the initial placement of the state object on user device 205. For example, data authority 230 and merchant computer 220 may agree on a common encryption/decryption key, or merchant computer 220 may send a decryption key to data authority 230. Alternatively, the airline merchant may simply notify data authority 230 as to what the encrypted state object 228 signifies, i.e., what the contents of the state object are. In this alternative approach, the contents of the state object 228 may be stored at a database of data authority 230 and associated with an identifier or index corresponding to the state object, so that the contents of a particular state object can later be retrieved when the identifier or index for that state object is presented. In some embodiments, the identifier or index may be randomly assigned or may be computed as a hash of information associated with the state object.

Referring to FIG. 2B, when user 201 later uses device 205 to visit a publisher web page 240, state object 228 is sent to a web server that serves web page 240. The web server then notifies data authority 230 that a targeted advertisement needs to be served and provides descriptive information about user 201. The descriptive information may include state object 228. The descriptive information may also include one or more of: IP address of user device 205, time of day of the web page access, operating system used by user device 205, language settings, and section of the website that user 201 is visiting (e.g., sports/business/fashion in the case of a news website). The state object 228 indicates the details of user 201's future travel to London. Thus, data authority 230 is able to identify based on the received state object 228 that the viewer of the publisher web page 240 will be traveling to London between Jul. 1 and Jul. 14, 2014. Based on that location and time frame information, a relevant advertisement 250 (e.g., for a music festival in London on Jul. 3, 2014 as in the above example) may be selected and served (e.g., included in ad space 242 of publisher web page 240 that is served to a web browser at user device 205).

Thus, various embodiments of the present disclosure make it possible to target advertisements to users (e.g., users who are browsing websites on the Internet) based on the users' future plans (e.g., future travel plans). The targeting of advertisements can be conducted in an anonymized fashion, such that an advertiser (e.g., a merchant or a manufacturer that wishes to advertises its goods or services) can advertise to a large group of potential customers without possessing personally identifiable information of the targeted group, provided that the information contained in the state object 228 or transmitted message 104 describes a plurality of individuals (e.g., more than a threshold number of people such as 10,000 people). Personally identifiable information (PII) may be information that may be used, alone or in conjunction with other sources, to uniquely identify a single individual. PII is described in detail in U.S. Patent Publication No. 2013/0024242 to Villars et al., entitled “Protecting Privacy in Audience Creation,” the entire contents of which are hereby incorporated by reference herein.

In some embodiments, a stored state object (e.g., cookie) does not include precise geolocation information (e.g., the identity or address of a restaurant that is visited) for privacy compliance. But, state and city information may be acceptable for inclusion in the state object. In some instances, it may be possible to identify people by a single geolocation in a privacy compliant manner, e.g., if a large event (such as a sporting event, concert, or festival) is scheduled with tens of thousands of attendees.

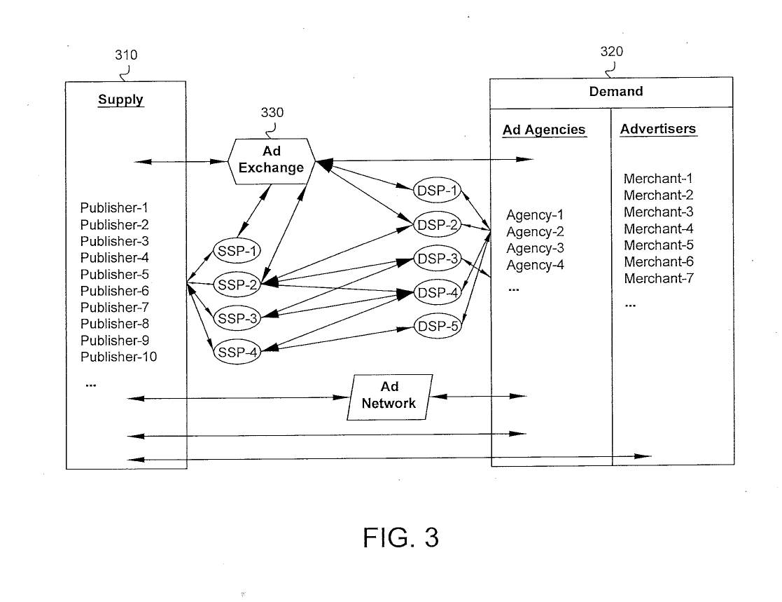

FIG. 3 is an illustration of relationships between various digital advertising participants for whom targeted advertising in accordance with some embodiments may be beneficial. At the left in FIG. 3 are shown supply side entities 310, and at the right in FIG. 3 are shown demand side entities 320. The supply side entities 310 (e.g., publishers denoted Publisher-1, . . . , Publisher-10) have a supply of something (e.g., ad space on web pages) that the demand side entities 320 have demand for. Advertisers such as Merchant-1, . . . , Merchant-7 shown in FIG. 3 may retain the services of ad agencies (shown as Agency-1, . . . , Agency-4) to manage ad campaigns for them.

Whereas FIGS. 1B and 2B show ad targeting database 110 and data authority 230 that provide targeted ads to a publisher web page, FIG. 3 shows details of how such ads originate and reach the publisher. For example, various intermediaries may be present as shown in FIG. 3. An ad exchange 330 is an online auction marketplace that facilitates the buying and selling of inventory (e.g., ad space) across multiple ad networks and demand side platforms (DSP's). An ad network is an online advertising service provider, often with proprietary technology, that helps marketers run display advertising campaigns across various sources of online inventory, including direct publishers and ad exchanges (e.g., ad exchange 330). A DSP is an advertising technology platform which allows marketers to manage their online media campaigns by facilitating the buying of auction-based display media and audience data across multiple inventor and data suppliers in a centralized management platform. Also shown in FIG. 3 are sell side platforms (SSP's) (sometimes referred to as supply side platforms), which are advertising technology platforms that represent the suppliers of online ads (i.e., publishers). Essentially, the intermediaries shown in FIG. 3 connect supply entities 310 with demand entities 320 in the advertising marketplace. The ads that demand entities 320 desire to display at available ad spaces may be tagged or associated with various attributes such as place and time attributes which can be utilized for targeting advertisements in accordance with various embodiments of the present disclosure.

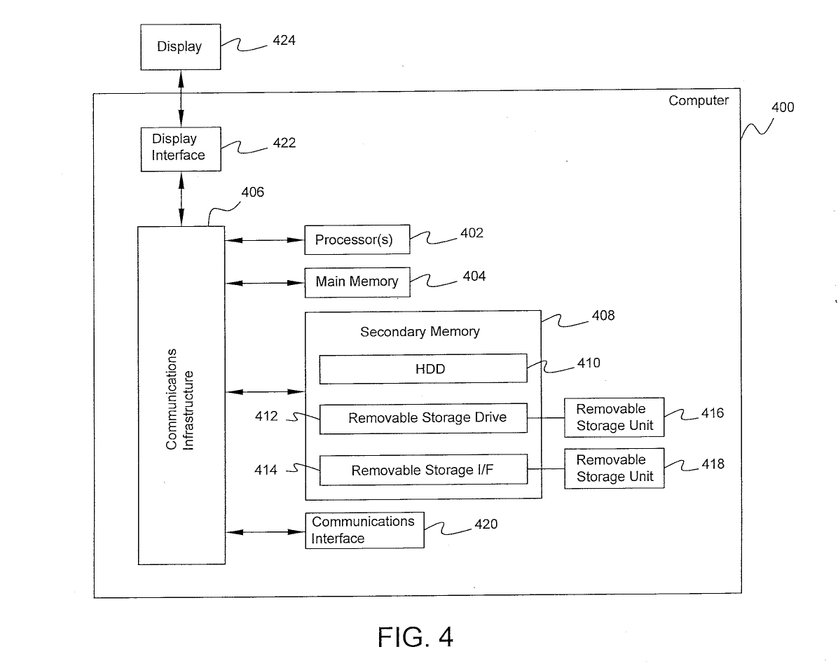

FIG. 4 is an architecture diagram of a computer 400 that may be used in some embodiments. The architecture of computer 400 may be used to implement user devices 105/205, merchant computers 102/220, message server 106, ad targeting engine 108, data authority 230, and/or a web server that servers publisher web page 120/240. Computer system 400 may include one or more processors 402. Each processor 402 is connected to a communication infrastructure 406 (e.g., a communications bus, cross-over bar, or network). Computer system 400 may include a display interface 422 that forwards graphics, text, and other data from the communication infrastructure 406 (or from a frame buffer, not shown) for display on the display unit 424.

Computer system 400 may also include a main memory 404, such as a random access memory (RAM), and a secondary memory 408. The secondary memory 408 may include, for example, a hard disk drive (HDD) 410 and/or removable storage drive 412, which may represent a floppy disk drive, a magnetic tape drive, an optical disk drive, a memory stick, or the like as is known in the art. The removable storage drive 412 reads from and/or writes to a removable storage unit 416. Removable storage unit 416 may be a floppy disk, magnetic tape, optical disk, or the like. As will be understood, the removable storage unit 416 may include a computer readable storage medium having tangibly stored therein (embodied thereon) data and/or computer software instructions, e.g., for causing the processor(s) to perform various operations.

In alternative embodiments, secondary memory 408 may include other similar devices for allowing computer programs or other instructions to be loaded into computer system 400. Secondary memory 408 may include a removable storage unit 418 and a corresponding removable storage interface 414, which may be similar to removable storage drive 412, with its own removable storage unit 416. Examples of such removable storage units include, but are not limited to, USB or flash drives, which allow software and data to be transferred from the removable storage unit 416, 418 to computer system 400.

Computer system 400 may also include a communications interface 420. Communications interface 420 allows software and data to be transferred between computer system 400 and external devices. Examples of communications interface 420 may include a modem, Ethernet card, wireless network card, a Personal Computer Memory Card International Association (PCMCIA) slot and card, or the like. Software and data transferred via communications interface 420 may be in the form of signals, which may be electronic, electromagnetic, optical, or the like that are capable of being received by communications interface 420. These signals may be provided to communications interface 420 via a communications path (e.g., channel), which may be implemented using wire, cable, fiber optics, a telephone line, a cellular link, a radio frequency (RF) link and other communication channels.

In this document, the terms “computer program medium” and “non-transitory computer-readable storage medium” refer to media such as, but not limited to, media at removable storage drive 412, or a hard disk installed in hard disk drive 410, or removable storage unit 416. These computer program products provide software to computer system 400. Computer programs (also referred to as computer control logic) may be stored in main memory 404 and/or secondary memory 408. Computer programs may also be received via communications interface 420. Such computer programs, when executed by a processor, enable the computer system 400 to perform the features of the methods discussed herein. For example, main memory 404, secondary memory 408, or removable storage units 416 or 418 may be encoded with computer program code (instructions) for performing operations corresponding to various processes disclosed herein.

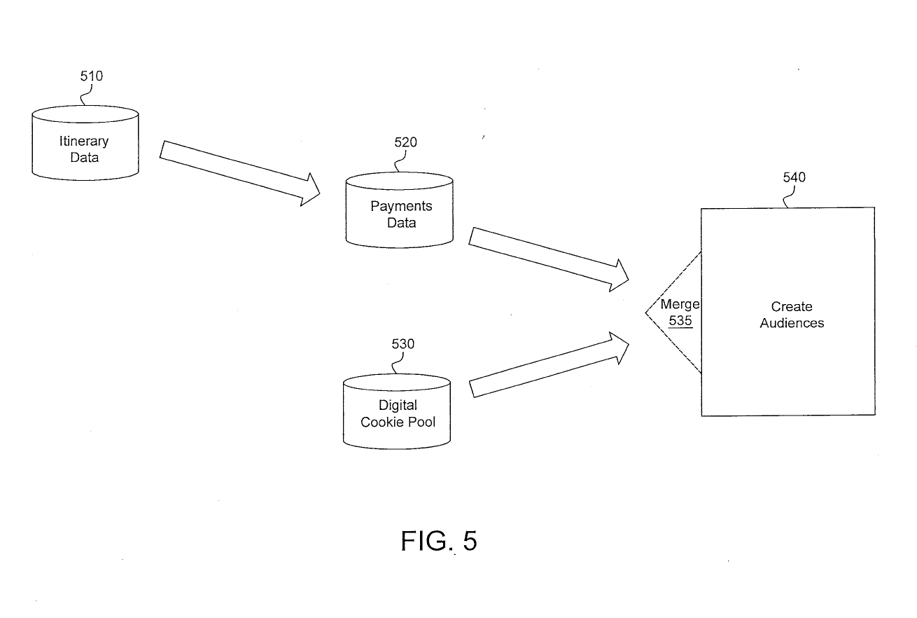

FIG. 5 is an illustration showing an example of using itinerary data for enriching other data for advertising purposes, in accordance with some embodiments. As discussed above in the context of FIGS. 1A, 1B, 2A, and 2B, plans about a consumer's future activities may include itinerary data that is determinable in accordance with various embodiments. Referring now to FIG. 5, itinerary data 510 can be used to enrich or supplement payments data 520 (purchase data) regarding purchases by various consumers. Payments data 520 may be in various formats, e.g., a format compatible with the ISO 8583 standard. The enrichment of payments data 520 based on itinerary data 510 can be implemented by linking itinerary data to payments data in various ways, e.g., by using a PAN (personal account number or primary account number), a loyalty number, a ticket number, etc. For example, an entity such as a card processor may have information about the purchases that various consumers have made at various merchants. The enriched data can be merged (535) with data from a digital cookie pool 530 to create audiences for online advertisements. Details regarding how payments data 520 and digital cookie pool 530 can be used to create audiences can be found at U.S. Patent Publication No. 2013/0024242 to Villars et al.

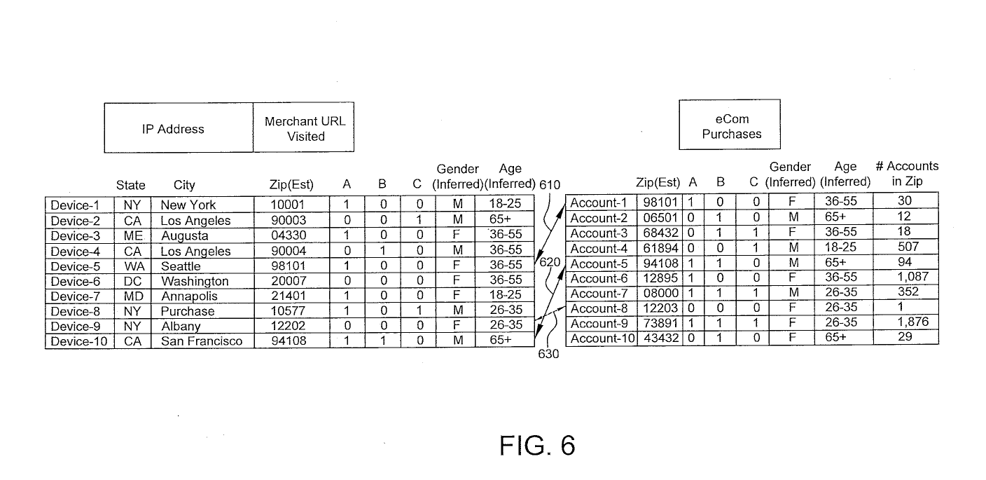

FIG. 6 shows an example technique for matching or linking device data to purchasing data. The left side of FIG. 6 shows data that is typically stored at user devices (e.g., user device 105 or 205) as a result of the devices being used for visiting merchant websites. In this example, various devices (labeled Device-1, . . . , Device-10) have visited websites (one or more of merchant websites A, B, and C), resulting in stored information (e.g., stored in cookies) about the user's city, state, and estimated zip code (these may be determined from the IP address of the device) as well as site visitation information. Additional attributes such as inferred gender and inferred age are also shown. The device data for devices Device-1, . . . , Device-10 may be obtained from a data management platform (DMP) such as Quantcast that has access to digital cookie pool 530.

The right side of FIG. 6 shows purchasing data. Various accounts (labeled Account-1, . . . , Account-10) are associated with one or more purchasing related attributes, e.g., number of purchases from respective merchants A, B, and C, and are optionally associated with fields such as an estimated zip code, number of accounts in that zip code, inferred gender, inferred age, and/or other demographic attributes. As shown by the solid arrows 610 and 620, an exact match (link) between device data and purchasing data may be made based on the same data being present in respective fields of the device data and purchasing data. A weak or fuzzy match may also be made as shown by dashed arrow 630, corresponding to a case in which one or more data fields of device data can be exactly matched to corresponding fields of purchasing data but another field (e.g., zip code) exhibits a minor discrepancy (e.g., difference at one digit). The technique shown in FIG. 6 is only one example, and other approaches for matching, linking, or merging data may be used as well.

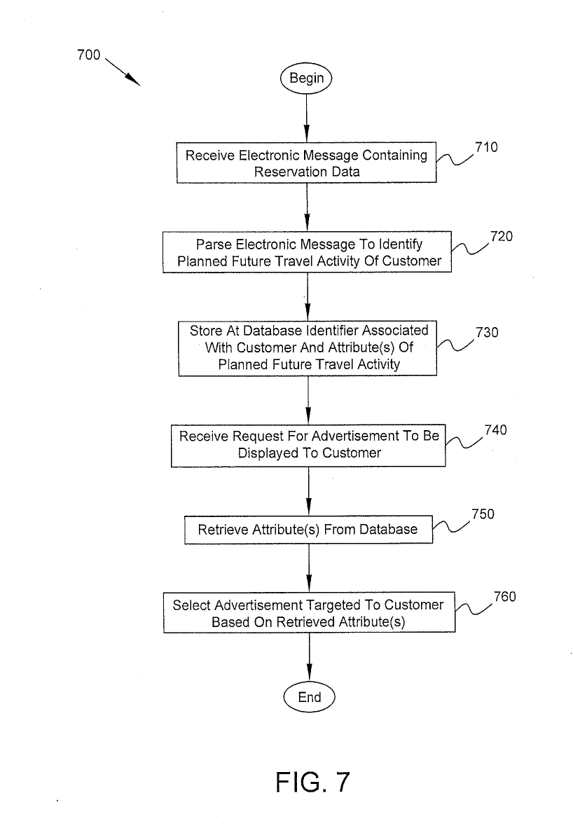

FIG. 7 is a flow diagram of a process in accordance with some embodiments. After process 700 begins, an electronic message containing reservation data is received (block 710). The reservation data of the electronic message is parsed with a computer processor to identify a planned future travel activity of a customer (block 720). An identifier associated with the customer and at least one attribute of the planned future travel activity are stored at a computer database (block 730). A request is received for an advertisement to be displayed to the customer (block 740). One or more of the attributes are retrieved from the database (block 750). An advertisement targeted to the customer is selected based on the retrieved attribute(s) (block 760).

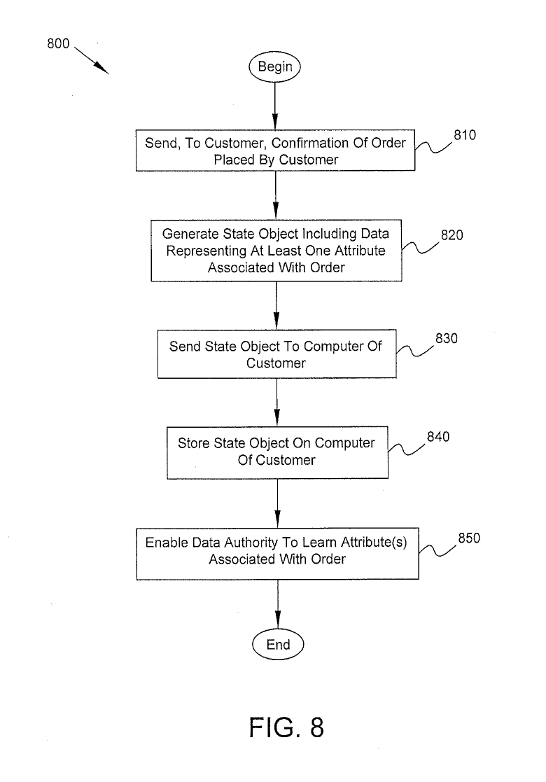

FIG. 8 is a flow diagram of a process in accordance with some embodiments. After process 800 begins, a confirmation of an order placed by a customer is sent to the customer (block 810). The order pertains to at least a portion of a planned future travel activity of the customer. A state object including data representing at least one attribute associated with the order is generated (block 820). The state object is sent to a computer of the customer (block 830). The state object is stored on the computer of the customer (block 840). A data authority is enabled to learn one or more of the attributes associated with the order (block 850).

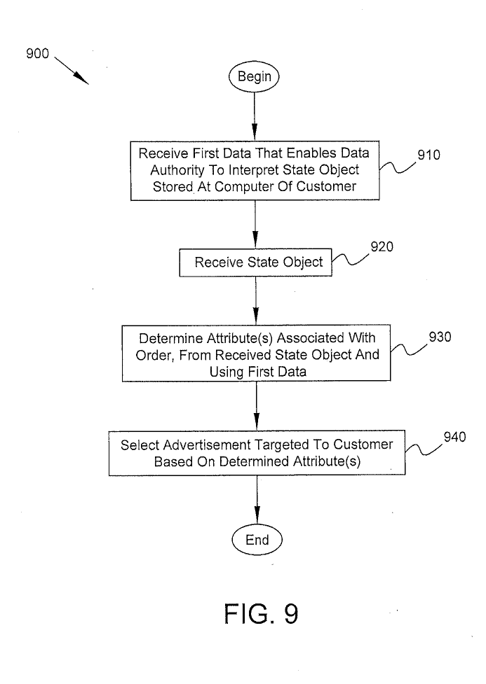

FIG. 9 is a flow diagram of a process in accordance with some embodiments. After process 900 begins, first data are received (block 910). The first data enables a data authority to interpret a state object stored at a computer of a customer. The state object includes second data representing at least one attribute associated with an order placed by the customer. The order pertains to at least a portion of a planned future travel activity of the customer; The state object is received (block 920), and from the received state object and using the first data, one or more of the attributes associated with the order are determined (block 930). An advertisement targeted to the customer is selected (block 940) based on the determined one or more attributes.

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other components and processes described herein.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A computer-implemented method for targeting advertising, the method comprising:
receiving an electronic message containing reservation data;
with a computer processor, parsing the reservation data of the electronic message to identify a planned future travel activity of a customer;
storing, at a computer database, an identifier associated with the customer and at least one attribute of the planned future travel activity;
receiving a request for an advertisement to be displayed to the customer;
retrieving one or more of the attributes from the database; and
selecting an advertisement targeted to the customer based on the retrieved one or more attributes.

2. The method of claim 1 wherein the electronic message is an email message.

3. The method of claim 1, wherein the electronic message originated from a merchant providing to the customer a product or service associated with the planned future travel activity.

4. The method of claim 1, wherein the at least one attribute includes a time associated with the planned future travel activity.

5. The method of claim 1, wherein the at least one attribute includes a place associated with the planned future travel activity.

6. The method of claim 1, further comprising sending the selected advertisement to a web server for the customer to view the advertisement at a web page hosted by the web server.

7. A computer-implemented method for targeting advertising, the method comprising:
sending to a customer a confirmation of an order placed by the customer, wherein the order pertains to at least a portion of a planned future travel activity of the customer;
generating a state object including data representing at least one attribute associated with the order;
sending the state object to a computer of the customer;
storing the state object on the computer of the customer; and
enabling a data authority to learn one or more of the attributes associated with the order.

8. The method of claim 7, wherein the state object is a browser cookie.

9. The method of claim 8, wherein the state object is an encrypted browser cookie.

10. The method of claim 7, wherein the state object is stored in encrypted form on the computer of the customer, and wherein enabling the data authority to learn one or more of the attributes includes sending to the data authority a decryption key capable of decrypting the encrypted state object.

11. The method of claim 7, wherein enabling the data authority to learn one or more of the attributes includes providing to the data authority the one or more of the attributes in unencrypted form.

12. The method of claim 7, wherein the at least one attribute includes a time associated with the planned future travel activity.

13. The method of claim 7, wherein the at least one attribute includes a place associated with the planned future travel activity.

14. A computer-implemented method for targeting advertising, the method comprising:
receiving first data that enables a data authority to interpret a state object stored at a computer of a customer, the state object including second data representing at least one attribute associated with an order placed by the customer, wherein the order pertains to at least a portion of a planned future travel activity of the customer;
receiving the state object;
determining, from the received state object and using the first data, one or more of the attributes associated with the order; and
selecting an advertisement targeted to the customer based on the determined one or more attributes.

15. The method of claim 14, wherein the first data originated from a merchant providing to the customer a product or service associated with the planned future travel activity.

16. The method of claim 14, wherein the state object is stored in encrypted form, and the first data includes a decryption key capable of decrypting the encrypted state object.

17. The method of claim 14, wherein the first data includes at least one of the attributes and a state object identifier.

18. The method of claim 14, further comprising sending the selected advertisement to a web server for the customer to view the advertisement at a web page hosted by the web server.

19. The method of claim 14, wherein the at least one attribute includes a time associated with the planned future travel activity.

20. The method of claim 14, wherein the at least one attribute includes a place associated with the planned future travel activity.
